(19) United States
(12) Patent Application Publication
(10) Pub. No.: US 2018/0246625 A1
(43) Pub. Date: Aug. 30, 2018

(54) METHOD AND APPARATUS FOR IMPLEMENTATION OF VIDEO PLAYBACK

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiaxi LUO, BEIJING (CN)

(21) Appl. No.: 15/120,302

(22) PCT Filed: May 27, 2016
(86) PCT No.: PCT/CN2016/083723

§ 371 Date: Aug. 19, 2016

(30) Foreign Application Priority Data
Nov. 20, 2015 (CN) 201510810749.7

(51) Int. Cl. G06F 3/0484; H04N 21/472; H04N 21/858

(52) U.S. Cl. CPC G06F 3/0484; H04N 21/47205; G06F 3/04842; G06F 2203/04803; H04N 21/8586

(57) ABSTRACT

Disclosed is a method and apparatus for implementation of video playback, the method comprising the steps of during the playback of a first video file, receiving a trigger instruction for playback of a second video file; setting a playback area of the first video file of the video playback page as a main screen, and setting another area of the video playback page as a sub-screen; extracting the playback address of the first video file and playing the first video file in the sub-screen accordingly; and acquiring the playback address of the second video file and playing the second video file in the main screen. Therefore, the method and apparatus for implementation of video playback can overcome the problem of switching between a plurality of video files by repeat jumping to different playback address or click to the playback pages of different playback address.

### CROSS-REFERENCE TO RELATED APPLICATIONS

This application is a continuation of International Application No. PCT/CN2016/083723, filed May 27, 2016, which is based upon and claims priority to Chinese Patent Application No. 2015108107497, filed Nov. 20, 2015, the entire contents of all of which are incorporated herein by reference.

### TECHNICAL FIELD

The present disclosure relates to media communication technology, in particular to a method and apparatus for implementation of video playback.

### BACKGROUND

With development of computer communication, internet and multimedia technologies, watching video has been more widely used; during watching a video, if the user expects to watch another video file, there are two play modes: one is that the user jumps from the video-playing page to the playback page of the video file what the user wants to watch; and the other is that the user opens and plays the video file what the user wants to watch in a new page.

However, in both modes, there is a problem that if the user wants to watch the previous video file again, the user can only jump back to the original playback address, or click to the playback page of the original video file. Thus, the repeat jumping or clicking cause a very complicated operation for the user and affect the user's experience of watching the previous and current video files.

### SUMMARY

In view of this, an object of the disclosure is to provide a method and apparatus for implementation of video playback to overcome the problem of switching between a plurality of video files by repeat jumping to different playback address or click to the playback pages of different playback address.

Based on the object, as an embodiment, the present disclosure provides a method for implementation of video playback, comprising the steps of:

at an electronic device:

during the playback of a first video file, receiving a trigger instruction of playing a second video file;

setting a playback area of the first video file of the video playback page as a main screen, and setting another playback area of the video playback page as a sub-screen;

extracting the playback address of the first video file and playing the first video file in the sub-screen accordingly; and

acquiring the playback address of the second video file and playing the second video file in the main screen.

Further, the step of setting another playback area as a sub-screen comprises the steps of:

pausing the first video file being played;

determining whether the sub-screen is set according to the preset default position and size;

based on the determining result, setting the sub-screen according to the default position and size or customizing position and size of the sub-screen in the video playback page.

Further, after the step of playing the second video file in the main screen, the method further comprises the steps of:

receiving a trigger instruction of clicking on the sub-screen; and

extracting the playback address and playback progress of the first video file in the sub-screen and playing the first video in the main screen accordingly;

extracting the playback address and playback progress of the second video file in the main screen, and playing the second video file in the sub-screen accordingly and closing the audio of the second video file.

Further, after the step of playing the second video file in the main screen, the method further comprises the steps of:

receiving a trigger instruction of deleting the sub-screen;

closing the video file being played in the sub-screen and deleting the sub-screen; or

receiving a trigger instruction of deleting the main screen;

extracting the playback address and playback progress of the video file being played in the sub-screen and playing the video file in the main screen accordingly, and closing the video file being played in the sub-screen and deleting the sub-screen.

Further, after the step of receiving the trigger instruction of deleting the main screen, the method further comprises the steps of:

acquiring the positions of the main screen and all the sub-screens in the video playback page;

according to the position of the main screen in the video playback page, determining the sub-screen closest to the main screen;

extracting the playback address and playback progress of the video file being played in the sub-screen closest to the main screen, playing the video file in the main screen accordingly, and closing the video file being played in the sub-screen and deleting the sub-screen.

In another aspect of an embodiment of the present disclosure, it is provided an apparatus for implementation of video playback, comprising:

a video playback triggering unit for during the playback of a first video file, receiving a trigger instruction of playing a second video file;

a video screen setting unit for setting a playback area of the first video file of the video playback page as a main screen, and setting another playback area of the video playback page as a sub-screen;

a video screen playback unit for extracting the playback address of the first video file and playing the first video file in the sub-screen accordingly; and acquiring the playback address of the second video file and playing the second video file in the main screen.

Further, the video screen setting unit for setting another playback area as a sub-screen is used for executing the steps of:

pausing the first video file being played;

determining whether the sub-screen is set according to the preset default position and size;

based on the determining result, setting the sub-screen according to the default position and size or customizing position and size of the sub-screen in the video playback page.

Further, after playing the second video file in the main screen, the video screen playback unit is used for executing the steps of:

receiving a trigger instruction of clicking on the sub-screen;

extracting the playback address and playback progress of the first video file in the sub-screen and playing the first video in the main screen accordingly; and

extracting the playback address and playback progress of the second video file in the main screen, and playing the second video file in the sub-screen accordingly and closing the audio of the second video file.

Further, after playing the second video file in the main screen, the video screen playback unit is used for executing the steps of:

receiving a trigger instruction of deleting the sub-screen;

closing the video file being played in the sub-screen and deleting the sub-screen; or

receiving a trigger instruction of deleting the main screen;

extracting the playback address and playback progress of the video file being played in the sub-screen and playing the video file in the main screen accordingly, and closing the video file being played in the sub-screen and deleting the sub-screen.

Further, after receiving the trigger instruction of deleting the main screen, the video screen playback unit is used for executing the steps of:

acquiring the positions of the main screen and all sub-screens in the video playback page;

according to the position of the main screen in the video playback page, determining the sub-screen closest to the main screen; and

extracting the playback address and playback progress of the video file being played in the sub-screen closest to the main screen, playing the video file in the main screen accordingly, and closing the video file being played in the sub-screen and deleting the sub-screen.

In a further another aspect of an embodiment of the present disclosure, it is provided an device, comprising:

flat least one processor(s); and

a memory communicably connected with the at least one processor for storing instructions executable by the at least one processor, wherein execution of the instructions by the at least one processor causes the at least one processor to:

during the playback of a first video file, receiving a trigger instruction of playing a second video file;

setting a playback area of the first video file of the video playback page as a main screen, and setting another playback area of the video playback page as a sub-screen;

extracting the playback address of the first video file and playing the first video file in the sub-screen accordingly; and

acquiring the playback address of the second video file and playing the second video file in the main screen.

Further, the processor is used for executing the steps of:

pausing the first video file being played;

determining whether the sub-screen is set according to the preset default position and size;

based on the determining result, setting the sub-screen according to the default position and size or customizing position and size of the sub-screen in the video playback page.

Further, after playing the second video file in the main screen, the processor is used for executing the steps of:

receiving a trigger instruction of clicking on the sub-screen;

extracting the playback address and playback progress of the first video file in the sub-screen and playing the first video in the main screen accordingly; and

extracting the playback address and playback progress of the second video file in the main screen, and playing the second video file in the sub-screen accordingly and closing the audio of the second video file.

Further, after playing the second video file in the main screen, the processor is used for executing the steps of:

receiving a trigger instruction of deleting the sub-screen;

closing the video file being played in the sub-screen and deleting the sub-screen; or

receiving a trigger instruction of deleting the main screen;

extracting the playback address and playback progress of the video file being played in the sub-screen and playing the video file in the main screen accordingly, and closing the video file being played in the sub-screen and deleting the sub-screen.

Further, after receiving the trigger instruction of deleting the main screen, the processor is used for executing the steps of:

acquiring the positions of the main screen and all sub-screens in the video playback page;

according to the position of the main screen in the video playback page, determining the sub-screen closest to the main screen; and

extracting the playback address and playback progress of the video file being played in the sub-screen closest to the main screen, playing the video file in the main screen accordingly, and closing the video file being played in the sub-screen and deleting the sub-screen.

A non-transitory computer-readable storage medium storing executable instructions that, when executed by an electronic device, cause the electronic device to:

during the playback of a first video file, receiving a trigger instruction of playing a second video file;

setting a playback area of the first video file of the video playback page as a main screen, and setting another playback area of the video playback page as a sub-screen;

extracting the playback address of the first video file and playing the first video file in the sub-screen accordingly; and

acquiring the playback address of the second video file and playing the second video file in the main screen.

In a word, the methods and apparatus for implementation of video playback provided by the embodiments of the present disclosure can achieve that the user can watch a plurality of video files in a video playback page simultaneously and the service of the video media can be improved, by the steps of during the playback of a first video file, receiving a trigger instruction for playback of a second video file; setting a playback area of the first video file of the video playback page as a main screen, and setting another area of the video playback page as a sub-screen; extracting the playback address of the first video file and playing the first video file in the sub-screen accordingly; and acquiring the playback address of the second video file and playing the second video file in the main screen.

It should be understood that both the descriptions in general and in detailed hereinafter are merely exemplary and explanatory without any limitation to the disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a method for implementation of video playback according to the first embodiment of the present disclosure;

FIG. 2 is a schematic flow diagram of a method for implementation of video playback according to a referable embodiment of the present disclosure;

FIG. 3 is a schematic view of an apparatus for implementation of video playback according to an embodiment of the present disclosure.

By the above drawings, the embodiments of the present disclosure have been shown clearly and will be described hereinafter in more detail. These drawings and description are not intended in any way to limit the scopes of the disclosure, but describe the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

According to the current utilization of multimedia platforms, during watching a video, if the user expects to watch another video file, the user only can jump from the current video-playing page to the playback address page of the another video file or open the playback address page of the another video file in a new page. When the user wants to watch the previous video file again, the user has to jump back to the original playback address or click to the playback page of the original video file, resulting in a poor user's experience. To solve this problem, the present disclosure started from the user's perspective and found that the user expects to watch a plurality of video files in the same video playback page. Thus, the idea of the present disclosure is to set a plurality of screens in a video playback page in the video media platform and playing different video files as required.

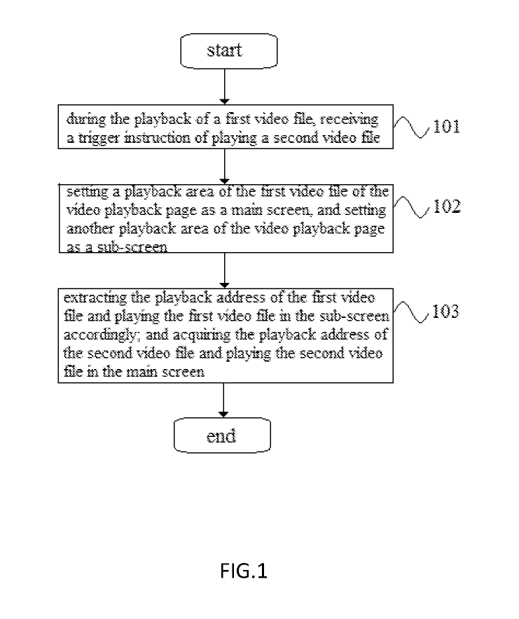

Referring to FIG. 1, a schematic flow diagram of a method for implementation of video playback according to the first embodiment of the present disclosure is shown, wherein the method for implementation of video playback comprises the following steps:

Step 101: during the playback of a first video file, receiving a trigger instruction of playing a second video file.

As a example, Step 101 comprises in a video application platform, during the playback of a first video file in a video playback page, receiving a playback instruction of clicking on another video file in the video application.

Step 102: setting a playback area of the first video file of the video playback page as a main screen, and setting another playback area of the video playback page as a sub-screen.

As an example, Step 102 comprises setting the playback area of playing the first video file of the video playback page as a main screen of the video playback page, and setting another playback area of the video playback page as a sub-screen of the video playback page. Further, the sub-screen is set on the area outside of the main screen in the video playback page, the object of which is to avoid the sub-screen being set over the main screen area to affect the user watching the main screen.

Further, when the sub-screen is set on the area outside of the main screen in the video playback page, the sub-screen can be set according to the preset default position and size, for example, the preset default position can be at 2 cm from the top right corner of the main screen, and the preset default size is 5 cm*5 cm.

In addition, the user may customize the position and size of the sub-screen as required. Specifically, when the user customize the position and size of the sub-screen, the user can enter the edit mode of the video playback page and draw a sub-screen on the area outside the main screen of the video playback page. For example, the user can use a mouse to draw an area outside the main screen as the sub-screen.

It should be noted that, when setting the sub-screen on the area outside the main screen of the video playback page, the user can pause the playing video file in the main screen and set the sub-screen outside the main screen.

It should be noted that, the size of the main screen should be larger than the size of the sub-screen in the video playback page, since what the user in general watches in the video playback page is mainly the video file in the main screen and a larger main screen than a sub-screen is benefit for the user's watching.

Step 103: extracting the playback address of the first video file and playing the first video file in the sub-screen accordingly; and acquiring the playback address of the second video file and playing the second video file in the main screen.

As an example, based on the acquired playback address of the second video file, the clicked second video file can be played in the main screen. In the sub-screen, the first video file can be played according to the extracted playback address and playback progress of the first video file. It should be noted that, since the audio of the video file played in the main screen and the audio of the video file played in the sub-screen are delivered to the user via the same channel of terminal device in the video playback page of a video application, the playback of both video files at the same time will occur an overlapped audio, which will affect the effect of the user watching video. Under normal circumstances, the user is mainly watching the video file played in the main screen in the video playback page, so that it can be set that the audio of the video file played in the main screen can be delivered via the channel, and all of the video files played in the sub-screen is set as mute.

In addition, in the method for implementation of video playback of the present disclosure, multiple (i.e., at least one) sub-screens can be set in the video playback page. When the user performs each click on a video file for watching, the clicked video files can be opened and played in the same video playback page through the above-mentioned method.

As another example, after Step 103 is executed, during the user watches multiple video files on the video playback page at the same time, if receiving a trigger instruction of clicking on the sub-screen, then extracting the playback address and playback progress of the playing video file in the sub-screen; and then, acquiring the playback address and playback progress of the playing video file in the main screen, playing the video file in the sub-screen and closing the audio of the video file. At the same time, according to the extracted playback address and playback progress of the playing video file in the sub-screen, playing the video file in the main screen.

Additionally, in another embodiment of the present disclosure, after Step 103 is executed, it may be received a trigger instruction of deleting the sub-screen, the video file being played in the sub-screen can be closed directly and the sub-screen can be deleted. It should be also noted that, the main screen and all the sub-screens in the video playback page can be moved on the video playback page, that is, the positions thereof can be changed. For example, the user can click but not release the main screen or any one of the sub-screens by mouse, and the position of the main screen or the sub-screen on the video playback page can be changed as the movement of the mouse.

Also, in an embodiment, after Step 103 is executed, it may be received a trigger instruction of deleting the main screen, then the video file being played in the main screen can be closed; the playback address and playback progress of the video file being played in the sub-screen can be extracted and the video file can be played in the main screen accordingly. At the same time, the video file being played in the sub-screen can be closed and the sub-screen can be deleted. Further, after receiving the trigger instruction of deleting the main screen, the positions of the main screen and all the sub-screens on the video playback page can be acquired. According to the position of the main screen in the video playback page, the sub-screen closest to the main screen is determined. And then, the playback address and playback progress of the video file being played in the sub-screen closest to the main screen is extracted and the video file is played in the main screen accordingly, and the video file being played in the sub-screen is closed and the sub-screen is deleted. Among them, when determining the sub-screen closest to the main screen, it can set the video playback page as a plane coordinate to determine the positions of the main screen and all the sub-screens in this coordinate and calculate the distance of each sub-screen from the main screen, and find the closest sub-screen to the main screen by the calculated results.

From some of the above embodiments, it can be seen that the method for implementation of video playback can achieve the function that the user can simultaneously watch multiple video files in a video playback page. The user also can exchange the video file being played in the main screen with that being played in any one of the sub-screens in the video playback page, to further satisfy the user's choice of watching different video files in the same video playback page. In addition, as for the video file that the user does not want to play anymore, no matter the video file in the main screen or the video file in any one of the sub-screens can be deleted, so as to improve the playback effectiveness of video files in the video playback page. Thus, the present disclosure creatively proposes a multi-screens video playback page, in which a plurality of demands of users can be satisfied to provide a new video watching experience for users. At the same time, the playback functions of the video application platform are be integrated to be convenient to the user's watching and greatly enhance the service quality of video application platforms.

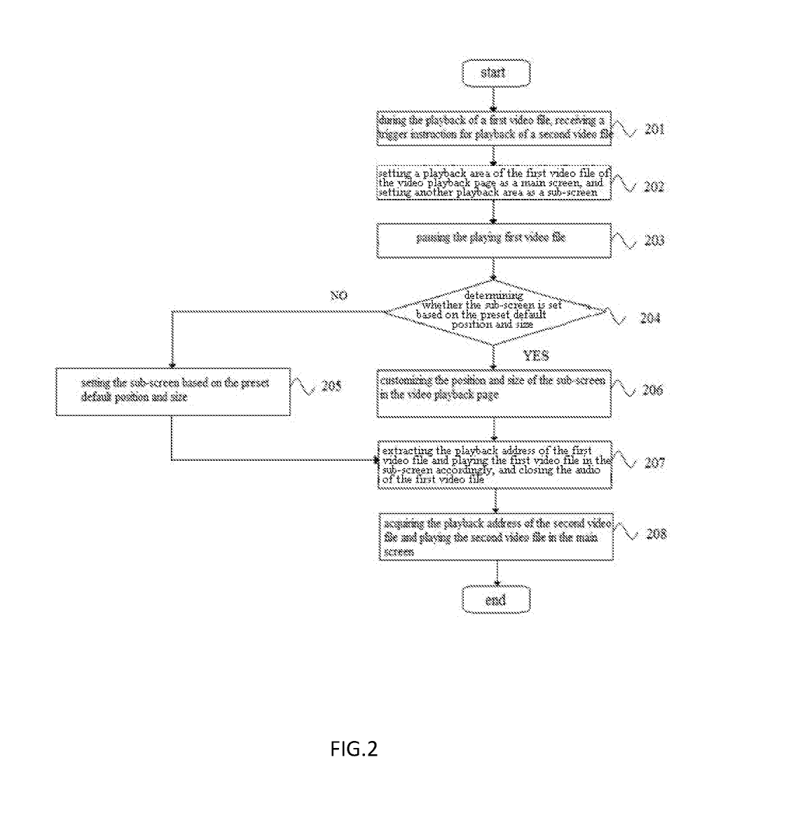

As a referable example, referring to FIG. 2, the method for implementation of video playback can be implemented specifically by the steps of:

Step 201: during the playback of a first video file, receiving a trigger instruction for playback of a second video file;

Step 202: setting a playback area of the first video file of the video playback page as a main screen, and setting another playback area as a sub-screen;

Step 203: pausing the playing first video file;

Step 204: determining whether the sub-screen is set based on the preset default position and size; if yes then executing Step 205; if no then executing Step 206;

Step 205: setting the sub-screen based on the preset default position and size, and executing Step 207;

Step 206: customizing the position and size of the sub-screen in the video playback page, and executing Step 207;

Step 207: extracting the playback address of the first video file and playing the first video file in the sub-screen accordingly, and closing the audio of the first video file;

Step 208: acquiring the playback address of the second video file and playing the second video file in the main screen.

It should be noted that, Step 207 and Step 208 may be executed in any order of Step 207 first and Step 208 second, or Step 208 first and Step 207 second, or Step 207 and Step 208 executed simultaneously.

As a further referable example, after Step 207 or Step 208 is executed or the both are executed simultaneously, the video files in the main screen and one of the sub-screens can be exchanged, comprising:

Step 1: receiving a trigger instruction of clicking on a sub-screen;

Step 2: extracting the playback address and playback progress of the video file being played in the sub-screen, and playing the video file in the main screen accordingly; and

Step 3: acquiring the playback address and playback progress of the video file being played in the main screen, and playing the video file in the sub-screen accordingly, and closing the audio of the video file.

It should be noted that, Step 2 and Step 3 can be executed in any sequence, that is, they can be executed in any order of Step 2 first and Step 3 second, or Step 3 first and Step 2 second, or Step 2 and Step 3 executed simultaneously.

As still another referable example, after Step 207 or Step 208 is executed or the both are executed simultaneously, the sub-screen in the video playback page can be deleted, comprising:

Step 1: receiving a trigger instruction of deleting the sub-screen;

Step 2, closing the video file being played in the sub-screen; and

Step 3: deleting the sub-screen.

As still another referable example, after Step 207 or Step 208 is executed or the both are executed simultaneously, the main screen in the video playback page can be deleted, comprising:

Step 1: receiving a trigger instruction of deleting the main screen;

Step 2, acquiring the position of the main screen and all the sub-screens on the video playback page;

Step 3: according to the position of the main screen in the video playback page, determining the sub-screen closest to the main screen;

Step 4: extracting the playback address and playback progress of the video file being played in the sub-screen closest to the main screen; and

Step 5: playing the video file in the main screen according to the playback address and playback progress of the video file being played in the sub-screen closest to the main screen, and closing the video file being played in the sub-screen and deleting the sub-screen.

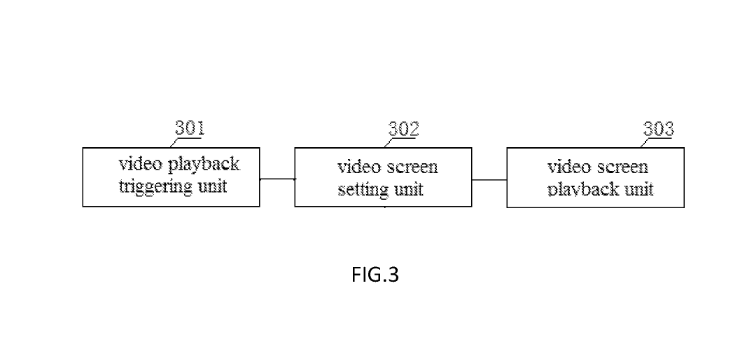

As a example of another aspect of the disclosure, it is provided an apparatus for implementation of video playback, as shown in FIG. 3. The apparatus for implementation of video playback comprises a video playback triggering unit 301, a video screen setting unit 302 and a video screen playback unit 303. The apparatus comprises a video playback triggering unit 301 for during the playback of a first video file, receiving a trigger instruction for playback of a second video file; a video screen setting unit 302 for setting a playback area of the first video file of the video playback page as a main screen, and setting another playback area of the video playback page as a sub-screen; and a video screen playback unit 303 for extracting the playback address of the first video file and playing the first video file in the sub-screen accordingly; and acquiring the playback address of the second video file and playing the second video file in the main screen.

Further, the video screen setting unit 302 can set the playback area of playing the first video file of the video playback page as a main screen of the video playback page and can set at least one sub-screen in the areas outside the main screen of the video playback page. Further, when the sub-screen is set on the area outside the main screen of the video playback page, the sub-screen can be set according to the preset default position and size. Of course, the user may customize the position and size of the sub-screen as required. Specifically, when the user customize the position and size of the sub-screen, the user can enter the edit mode of the video playback page and draw a sub-screen on the area outside the main screen of the video playback page.

It should be noted that, the size of the main screen should be larger than the size of the sub-screen in the video playback pages, since what the user in general watches in the video playback page mainly is the video file in the main screen and a larger main screen than a sub-screen is benefit for the user's watching. In addition, since the audio of the video file played in the main screen and the audio of the video file played in the sub-screen are transmitted to the user via the same channel of terminal device in the video playback page of a video application, the playback of both video files at the same time will appear an overlapped audio, which will affect the effect of the user watching video. Under normal circumstances, the users is mainly watching the video file played in the main screen in the video playback page, so that it can be set that the audio of the video file played in the main screen can be transmitted via the channel, and all of the video files played in the sub-screen is set as mute.

As another example, during the user is watching multiple video files on the video playback page at the same time, if the video screen playback unit 303 receives a trigger instruction of clicking on the sub-screen, then extracting the playback address and playback progress of the playing video file in the sub-screen and playing the video file in the main screen accordingly; acquiring the playback address and playback progress of the video file being played in the main screen; playing the video file in the sub-screen; and closing the audio of the video file.

As another referable example, during the user is watching multiple video files on the video playback page at the same time, the video screen playback unit 303 may receive a trigger instruction of deleting the sub-screen, then the video file being played in the sub-screen can be closed directly and the sub-screen can be deleted.

In addition, during the user is watching multiple video files on the video playback page at the same time, if the video screen playback unit 303 receives a trigger instruction of deleting the main screen, then the video file being played in the main screen can be closed; the playback address and playback progress of the video file being played in the sub-screen can be extracted and the video file can be played in the main screen accordingly. At the same time, the video file being played in the sub-screen can be closed and the sub-screen can be deleted. Further, after receiving the trigger instruction of deleting the main screen, the positions of the main screen and all the sub-screens on the video playback page can be acquired. According to the position of the main screen in the video playback page, the sub-screen closest to the main screen is determined. And then, the playback address and playback progress of the video file being played in the sub-screen closest to the main screen is extracted and the video file is played in the main screen accordingly, and the video file being played in the sub-screen is closed and the sub-screen is deleted.

It should be noted that the detailed embodiments of the apparatus for implementation of video playback of the present disclosure have been described in detail in the description of the method for implementation of video playback hereinbefore, so it is no longer to repeat the description.

In a further another aspect of an embodiment of the present disclosure, it is provided an device, comprising:

at least one processor(s); and

a memory communicably connected with the at least one processor for storing instructions executable by the at least one processor, wherein execution of the instructions by the at least one processor causes the at least one processor to:

during the playback of a first video file, receiving a trigger instruction for playback of a second video file;

setting a playback area of the first video file of the video playback page as a main screen, and setting another playback area of the video playback page as a sub-screen;

extracting the playback address of the first video file and playing the first video file in the sub-screen accordingly; and

acquiring the playback address of the second video file and playing the second video file in the main screen.

Further, the processor is used for executing the steps of:

pausing the first video file which is playing;

determining whether the sub-screen is set according to the preset default position and size;

based on the determining result, setting the sub-screen according to the default position and size or setting the sub-screen according to a custom position and size in the video playback page.

Further, after playing the second video file in the main screen, the processor is used for executing the steps of:

receiving a trigger instruction of clicking on the sub-screen;

extracting the playback address and playback progress of the first video file in the sub-screen and playing the first video in the main screen accordingly; and

extracting the playback address and playback progress of the second video file in the main screen, and playing the second video file in the sub-screen accordingly and closing the audio of the second video file.

Further, after playing the second video file in the main screen, the processor is used for executing the steps of:

receiving a trigger instruction of deleting the sub-screen;

closing the video file played in the sub-screen and deleting the sub-screen; or

receiving a trigger instruction of deleting the main screen;

extracting the playback address and playback progress of the video file played in the sub-screen and playing the video file in the main screen accordingly, and closing the video file played in the sub-screen and deleting the sub-screen.

Further, after receiving the trigger instruction of deleting the main screen, the processor is used for executing the steps of:

acquiring the positions of the main screen and all sub-screens in the video playback page;

according to the position of the main screen in the video playback page, determining the sub-screen closest to the main screen; and

extracting the playback address and playback progress of the video file played in the sub-screen closest to the main screen, playing the video file in the main screen accordingly, and closing the video file played in the sub-screen and deleting the sub-screen.

In a word, the methods and apparatus for implementation of video playback provided by the embodiments of the present disclosure creatively overcome the problem that a video playback page of video application platform only can play one video file and can achieve a function that a plurality of video files can be played in a video playback page simultaneously, so that the contents of the video playback page are richer, the user's various watching demands can be satisfied and can be widely promoted. Finally, the method and apparatus for implementation of video playback are compact and easy to implement.

In addition, typically, the apparatus or terminal device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and apparatus can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct Ram bus RAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Further, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can comprise RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for implementation of video playback, comprising the steps of:
at an electronic device:
during the playback of a first video file, receiving a trigger instruction of playing a second video file;
setting a playback area of the first video file of the video playback page as a main screen, and setting another playback area of the video playback page as a sub-screen;
extracting the playback address of the first video file and playing the first video file in the sub-screen accordingly; and
acquiring the playback address of the second video file and playing the second video file in the main screen.

2. The method according to claim 1, wherein the step of setting another playback area as a sub-screen comprises the steps of:
pausing the first video file being played;
determining whether the sub-screen is set according to the preset default position and size;
based on the determining result, setting the sub-screen according to the default position and size or customizing position and size of the sub-screen in the video playback page.

3. The method according to claim 2, wherein after the step of playing the second video file in the main screen, the method further comprises the steps of:
receiving a trigger instruction of clicking on the sub-screen; and
extracting the playback address and playback progress of the first video file in the sub-screen and playing the first video file in the main screen accordingly;
extracting the playback address and playback progress of the second video file in the main screen, and playing the second video file in the sub-screen accordingly and closing the audio of the second video file.

4. The method according to claim 1, wherein after the step of playing the second video file in the main screen, the method further comprises the steps of:
receiving a trigger instruction of deleting the sub-screen;
closing the video file being played in the sub-screen and deleting the sub-screen; or
receiving a trigger instruction of deleting the main screen;
extracting the playback address and playback progress of the video file being played in the sub-screen and playing the video file in the main screen accordingly, and closing the video file being played in the sub-screen and deleting the sub-screen.

5. The method according to claim 4, wherein after the step of receiving the trigger instruction of deleting the main screen, the method further comprises the steps of:
acquiring the positions of the main screen and all the sub-screens in the video playback page;
according to the position of the main screen in the video playback page,’ determining the sub-screen closest to the main screen; and
extracting the playback address and playback progress of the video file being played in the sub-screen closest to the main screen, playing the video file in the main screen accordingly, and closing the video file being played in the sub-screen and deleting the sub-screen.

6. A device, comprising:
at least one processor(s); and
a memory communicably connected with the at least one processor for storing instructions executable by the at least one processor, wherein execution of the instructions by the at least one processor causes the at least one processor to:
during the playback of a first video file, receiving a trigger instruction of playing a second video file;
setting a playback area of the first video file of the video playback page as a main screen, and setting another playback area of the video playback page as a sub-screen;
extracting the playback address of the first video file and playing the first video file in the sub-screen accordingly; and
acquiring the playback address of the second video file and playing the second video file in the main screen.

7. The device according to claim 6, wherein the processor is used for executing the steps of:
pausing the first video file being played;
determining whether the sub-screen is set according to the preset default position and size;
based on the determining result, setting the sub-screen according to the default position and size or customizing position and size of the sub-screen in the video playback page.

8. The device according to claim 7, wherein after playing the second video file in the main screen, the processor is used for executing the steps of:
receiving a trigger instruction of clicking on the sub-screen;
extracting the playback address and playback progress of the first video file in the sub-screen and playing the first video file in the main screen accordingly; and
extracting the playback address and playback progress of the second video file in the main screen, and playing the second video file in the sub-screen accordingly and closing the audio of the second video file.

9. The device according to claim 6, wherein after playing the second video file in the main screen, the processor is used for executing the steps of:
receiving a trigger instruction of deleting the sub-screen;
closing the video file being played in the sub-screen and deleting the sub-screen; or
receiving a trigger instruction of deleting the main screen;
extracting the playback address and playback progress of the video file being played in the sub-screen and playing the video file in the main screen accordingly, and closing the video file being played in the sub-screen and deleting the sub-screen.

10. The device according to claim 9, wherein after receiving the trigger instruction of deleting the main screen, the processor is used for executing the steps of:
acquiring the positions of the main screen and all sub-screens in the video playback page;
according to the position of the main screen in the video playback page, determining the sub-screen closest to the main screen; and
extracting the playback address and playback progress of the video file being played in the sub-screen closest to the main screen, playing the video file in the main screen accordingly, and closing the video file being played in the sub-screen and deleting the sub-screen.

11. A non-transitory computer-readable storage medium storing executable instructions that, when executed by an electronic device, cause the electronic device to:
during the playback of a first video file, receiving a trigger instruction of playing a second video file;
setting a playback area of the first video file of the video playback page as a main screen, and setting another playback area of the video playback page as a sub-screen;
extracting the playback address of the first video file and playing the first video file in the sub-screen accordingly; and
acquiring the playback address of the second video file and playing the second video file in the main screen.
